(19) United States
(12) Patent Application Publication
(10) Pub. No.: US 2012/0185458 A1
(43) Pub. Date: Jul. 19, 2012

(54) CLUSTERING CROWD-SOURCED DATA TO IDENTIFY EVENT BEACONS

(75) Inventors: Weili Liu, Redmond, WA (US); Sindhura Bandhakavi, Redmond, WA (US); Jyh-Han Lin, Mercer Island, WA (US)

(73) Assignee: MICROSOFT CORPORATION, Redmond, WA (US)

(21) Appl. No.: 13/008,033

(22) Filed: Jan. 18, 2011

(51) Int. Cl. G06F 17/30

(52) U.S. Cl. 707/709; 707/737; 707/E17.089; 707/E17.108

(57) ABSTRACT

Embodiments for identifying event beacons are provided. Position observations for a beacon are grouped into a plurality of clusters based at least on spatial distance. A location of each cluster is compared to event locations corresponding to events. Based on the comparison, the beacon is associated with the event, and the location of the beacon is set to the location of the event. In some embodiments, location requests are analyzed to identify event beacons, and the event information for the event beacons is used to identify event locations in response to the location requests.

### BACKGROUND

While some wireless access points are stationary, other wireless access points change positions. For example, during event or conference gatherings, a group of temporary wireless access points is typically established for the participants of the event. These temporary wireless access points often move together, following the event year to year. For example, a group of wireless access points may be observed in New Orleans one year, and then observed in Seattle the next year.

For some location service providers, this conflicting position information for the group of temporary wireless access points can adversely affect the location determinations provided to users by the location service providers. In the example above, some location service providers will determine that a user is in New Orleans, even though the user is in Seattle. These location service providers fail to recognize and adjust for such temporary wireless access points.

### SUMMARY

Embodiments of the disclosure associate a beacon with an event. A computing device identifies a plurality of clusters of position observations for a beacon. The clusters are defined by spatial distance and each of the plurality of clusters has a location associated therewith. A location of each of the plurality of clusters is compared with event locations. Each of the event locations corresponds to at least one event. Based on the comparison, the beacon is associated with the event.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a plurality of mobile computing devices providing crowd-sourced data to a cloud-based location service.

FIG. 2 is an exemplary block diagram illustrating operation of the location service to calculate beacon position information.

FIG. 3 is an exemplary block diagram illustrating a computing device with computer-executable components for determining the position of a beacon using event information.

FIG. 4 is an exemplary flow chart illustrating operation of the computing device to compare cluster locations with event locations to identify an event beacon.

FIG. 5 is an exemplary flow chart illustrating a clustering analysis of position observations.

FIG. 6 is an exemplary flow chart illustrating operation of the computing device to determine the position of a mobile computing device using event locations.

FIG. 7 is an exemplary map showing two clusters of position observations.

Corresponding reference characters indicate corresponding parts throughout the drawings.

### DETAILED DESCRIPTION

Embodiments of the disclosure identify event beacons by correlating position observations 204 to event information 110. In some embodiments, the position observations 204 are grouped into clusters based on distance and/or time that are then compared to event locations 310 included in the event information 110.

Aspects of the disclosure enable a location service 106 to accommodate event beacons or other temporary wireless access points when providing location determinations. For example, when a user sends a location request to the location service 106 with a set of observed beacons 104 including at least one event beacon, the location service 106 resolves the position of the user by checking coherency with known beacon position data and event information 110. As such, the location service 106 is able to more accurately determine the location of the user.

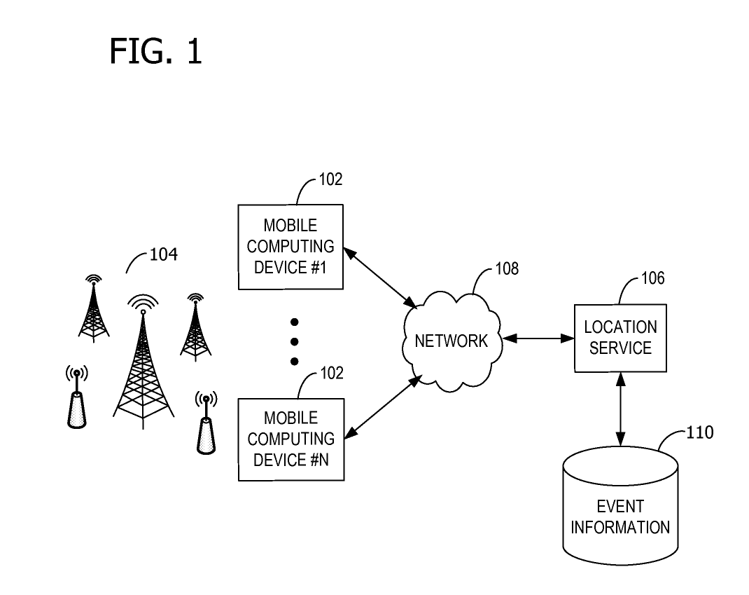

Referring next to FIG. 1, an exemplary block diagram illustrates a plurality of mobile computing devices 102 providing crowd-sourced data to a cloud-based location service 106. The plurality of mobile computing devices 102 include, for example, mobile computing device #1 through mobile computing device #N. In some embodiments, the mobile computing devices 102 include a mobile telephone, laptop, netbook, gaming device, and/or portable media player. The mobile computing devices 102 may also include less portable devices such as desktop personal computers, kiosks, and tabletop devices. Additionally, each of the mobile computing devices 102 may represent a group of processing units or other computing devices.

The mobile computing devices 102 observe or otherwise detect one or more beacons 104 or other cell sites. The beacons 104 represent network elements for connecting the mobile computing devices 102 to other computing devices and/or network elements. Exemplary beacons 104 include cellular towers, base stations, base transceiver stations, base station sites, and/or any other network elements supporting any quantity and type of communication modes. Aspects of the disclosure are operable with any beacon 104 supporting any quantity and type of wireless and/or wired communication modes including cellular division multiple access (CDMA), Global System for Mobile Communication (GSM), wireless fidelity (WiFi), 4G/Wi-Max, and the like.

Each of the mobile computing devices 102 stores properties or dimensions for each observed beacon 104. In some embodiments, exemplary properties include a latitude and longitude of the observing mobile computing device 102 (or other description of the location of the mobile computing device 102), and an observation time. Other exemplary properties are contemplated, however. For example, other exemplary properties include a signal strength, an access point name (APN), and a destination device to which the mobile computing device 102 is connected or attempting to connect.

When the observations are collected, a first observed time and a last observed time across the collected observations are identified as described below. The first observed time and the last observed time represent the earliest time and the most recent time, respectively, that the mobile computing devices 102 observed the particular beacon 104. Each mobile computing device 102, however, sends only one observation time associated with observation of the beacon 104.

The mobile computing devices 102 send the properties as position observations 204 to the location service 106 via a network 108. The network 108 includes any means for communication between the mobile computing devices 102 and the location service 106.

The location service 106 has access to event information 110. The event information 110 describes gatherings, conferences, or any other events 308. The event information 110 may be generated or collected automatically or manually, and may describe events 308 occurring locally, regionally, or across the world. Aspects of the disclosure are operable with event information 110 stored and/or organized in any format. For example, the event information 110 may include structured conference information describing events 308. In some embodiments, the event information 110 is stored by, or otherwise associated with, the location service 106. In other embodiments, the event information 110 is provided and maintained by an entity separate from the location service 106. For example, the event information 110 may be obtained via an application programming interface (API) function call to determine if there is an event 308 during a time frame near a particular location. An exemplary API function call is CheckConf (tₛₜₐᵣₜ, t_{end}, location) with the following exemplary input parameters:

tₛₜₐᵣₜ, t_{end}: the start and end time of the time frame of interest (e.g. in coordinated universal time)

location: location to check (e.g., as planetary coordinates including a latitude and longitude)

If there is an event 308 during the input time frame and near the input location, the function call returns information available for the conference. For example, the function call may return the conference name, sponsor company, and location of the conference (e.g., location(Cₖ), which is the location of event Cₖ (e.g., in planetary coordinates)). If there is no matching event, the function call returns null or a negative indication.

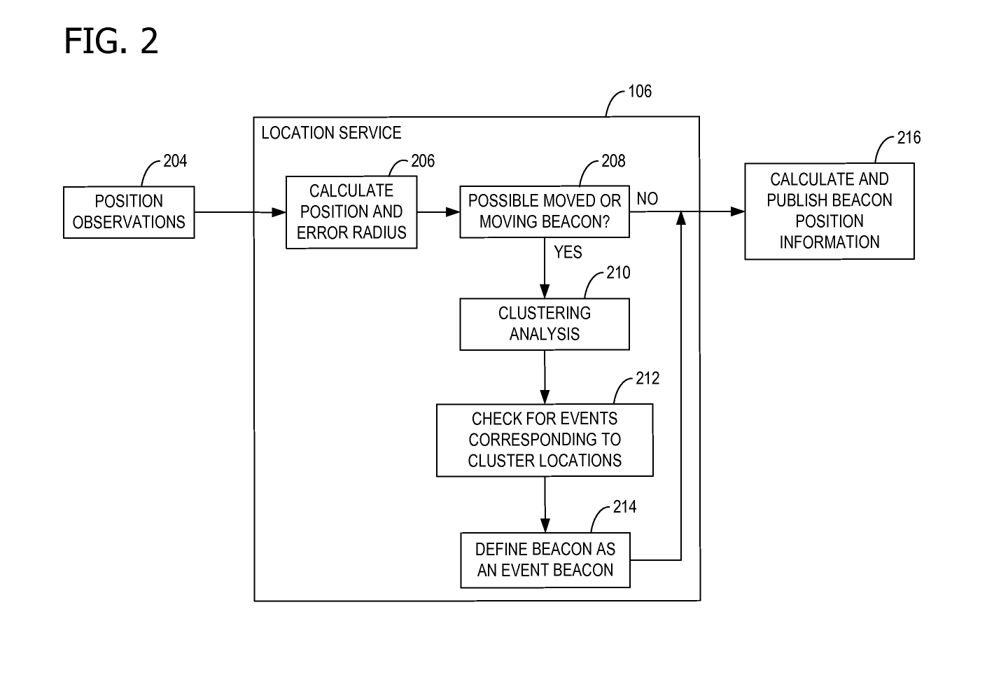

While described in the context of the location service 106 receiving and processing the observations, aspects of the disclosure contemplate other entities that receive and/or process the position observations 204. The entities include, for example, a cloud-based service, a server, and/or a peer device. The functionality of the location service 106, as described herein, may also be divided among one or more entities. For example, one entity may collect the position observations 204 into a storage area for subsequent processing by the location service 106. The position observations 204 may be processed as they are received (e.g., in real time), or may be stored for future processing (e.g., as a batch). In the example of FIG. 1, the location service 106 performs the functionality next described with reference to FIG. 2.

Referring next to FIG. 2, an exemplary block diagram illustrates operation of the location service 106 to calculate beacon position information. The location service 106 receives the position observations 204. In some embodiments, receiving the position observations 204 includes receiving, from a mobile computing device 102, a location of the mobile computing device 102 along with a set of beacons 104 observed by the mobile computing device 102. The location and set of beacons 104 may constitute a record representing crowd-sourced data obtained by the mobile computing device 102.

The location service 106 calculates a position and associated error radius for each observed beacon 104 at 206 using the position observations involving that beacon 104. In some embodiments, the error radius represents a range for the beacon 104. The error radius may be dependent on various factors such as beacon type and/or signal strength. The error radius may correspond to, for example, a radius of a circle or other shape (regular or irregular) representing a coverage area for the beacon 104.

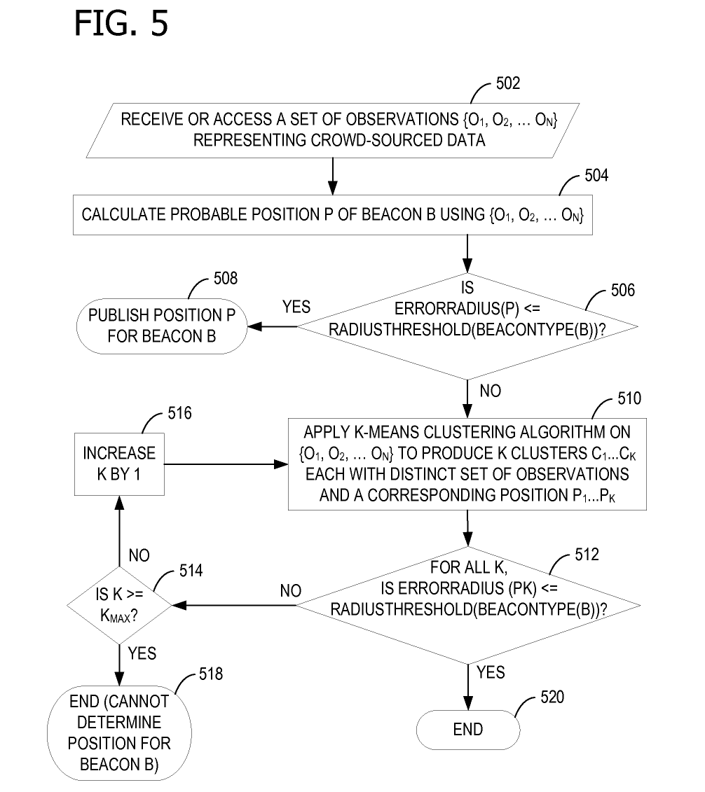

If the location service 106 determines that the beacon 104 is not a moved or moving beacon at 208 (e.g., see FIG. 5), the location service 106 publishes the calculated beacon position and error radius at 216 as the position information for the beacon 104. Alternatively, based on the calculated position and error radius, the location service 106 may conclude that the beacon 104 is possibly a moved beacon or a moving beacon at 208 (e.g., see FIG. 5), which is an indication that the beacon 104 may be an event beacon. If the location service 106 makes such a conclusion, then a clustering analysis is performed at 210. In some embodiments, the cluster analysis includes identifying a plurality of clusters of the position observations 204 for the beacon 104 based on spatial distance. The positions observations are grouped to form the clusters. The location of each of the identified plurality of clusters is calculated.

The location of each cluster is compared to event locations 310 from the event information 110 at 212. Based on a correspondence between the cluster locations and the event locations 310, the beacon 104 may be associated with the event 308. Accordingly, the beacon 104 is defined as an event beacon at 214. The location service 106 publishes the corresponding or matching event location 310 as the location of the event beacon at 216.

In some embodiments, each of the clusters also has a time or time range. The time is based on the times associated with the position observations 204 that form each corresponding cluster. In such embodiments, comparing the location of each cluster with the event locations 310 includes comparing the time or time ranges of each cluster with event times associated with each event location 310.

In the example of FIG. 2, the location service 106 outputs the beacon position information. In other examples, the location service 106 may output other determinations such as whether the beacon 104 is an event beacon, whether the beacon 104 has moved, whether the beacon 104 should be considered a moving beacon, and a set of possible locations for the beacon 104.

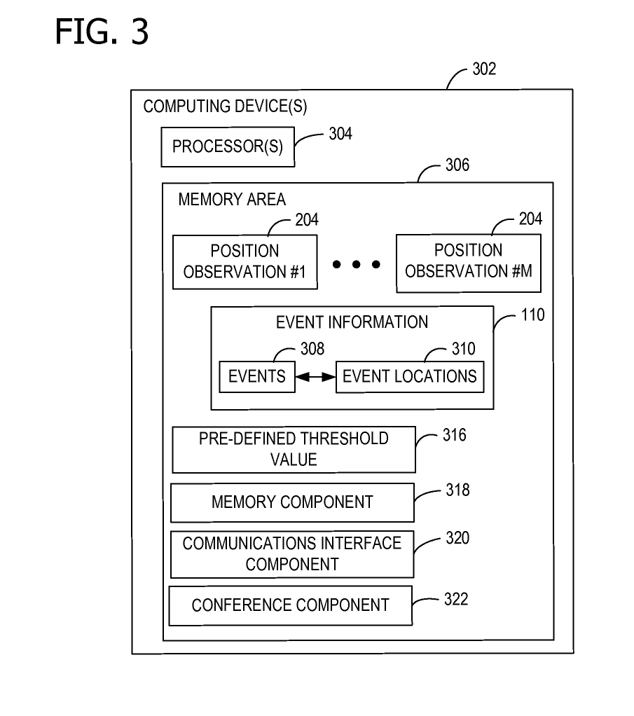

Referring next to FIG. 3, an exemplary block diagram illustrates one or more computing devices 302 with computer-executable components for determining the position of a beacon 104 using event information 110. In some embodiments, the computing devices 302 represent a cloud-based location determination system such as location service 106 involving a group of processing units or other computing devices. In general, the computing device 302 represents any device executing instructions (e.g., as application programs, operating system functionality, or both) to implement the operations and functionality associated with the computing device 302.

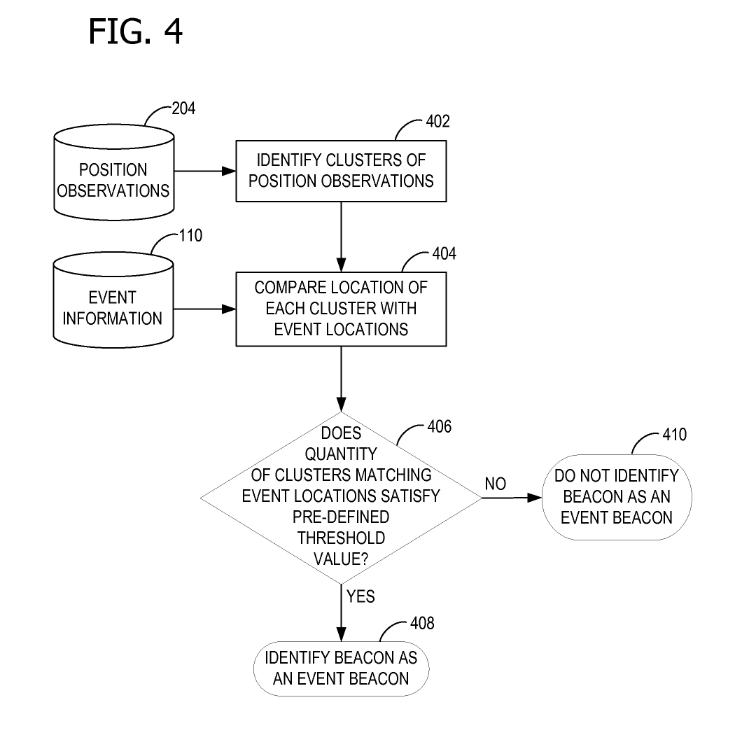

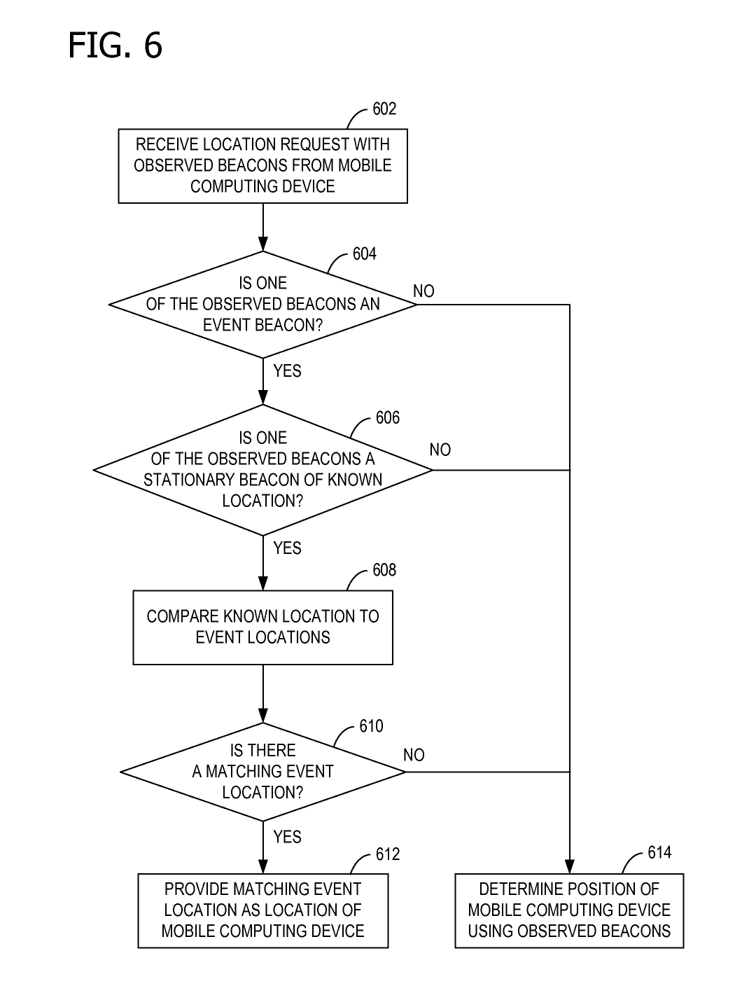

The computing device 302 has at least one processor 304 and a memory area 306. The processor 304 includes any quantity of processing units, and is programmed to execute computer-executable instructions for implementing aspects of the disclosure. The instructions may be performed by the processor 304 or by multiple processors executing within the computing device 302, or performed by a processor external to the computing device 302. In some embodiments, the processor 304 is programmed to execute instructions such as those illustrated in the figures (e.g., FIG. 4, FIG. 5, and FIG. 6).

The computing device 302 further has one or more computer-readable media such as the memory area 306. The memory area 306 includes any quantity of media associated with or accessible by the computing device 302. The memory area 306 may be internal to the computing device 302 (as shown in FIG. 3), external to the computing device 302 (not shown), or both (not shown).

The memory area 306 stores, among other data, a plurality of the position observations 204 such as position observation #1 through position observation #M. Each of the position observations 204 represents detection by a computing device (e.g., mobile computing device 102) of a beacon 104 at a particular time. Each of the position observations 204 includes a timestamp representing the time of observation of the beacon 104 by the mobile computing device 102.

In some embodiments, the computing device 302 includes a network interface card and/or computer-executable instructions (e.g., a driver) for operating the network interface card to receive the position observations 204. In other embodiments (not shown), the position observations 204 are stored in a storage area separate from the computing device 302. In such embodiments, the computing device 302 accesses the storage area to process the position observations 204.

The memory area 306 further stores the event information 110. The event information 110 includes a description of events 308 and corresponding event locations 310. In some embodiments, the event information 110 includes other information such as event times, organizing entity, sponsors, and the like. The event information 110 relates to past events, present events, and/or future events. The event information 110 may be obtained by the computing device 302 in several ways. For example, the event information 110 may be obtained directly by the computing device 302 via a web crawler that visits event web sites. In another example, the computing device 302 may subscribe to a third-party service to receive the event information 110. In still another example, the computing device 302 may use an API to make a function call to obtain event information 110 based on time, approximate location, and/or other factors.

The memory area 306 further stores at least one pre-defined threshold value 316. The pre-defined threshold value 316 is used to aid in determining whether a beacon 104 is an event beacon (e.g., see FIG. 5). The pre-defined threshold value 316 may be defined by an operator of computing device 302, defined heuristically, and/or defined by other means.

The memory area 306 further stores one or more computer-executable components. Exemplary components include a memory component 318, a communications interface component 320, and a conference component 322. Operation of the computer-executable components is described below with reference to FIG. 6.

Referring next to FIG. 4, an exemplary flow chart illustrates operation of the computing device 302 to compare cluster locations with event locations 310 to identify an event beacon. The computing device 302 receives or accesses the position observations 204 relating to beacons 104. In some embodiments, the computing device 302 filters or otherwise searches the position observations 204 to obtain the position observations 204 relating to a particular beacon 104 of interest. At 402, the computing device 302 identifies a plurality of clusters of the position observations 204 for the beacon 104 (e.g., see FIG. 5), and computes a location for each of the clusters. At 404, the computing device 302 compares the location of each cluster with event locations 310 to identify matching events. The event locations 310 are available from event information 110 stored by the computing device 302 and/or provided by a third-party service (e.g., via an API call). If enough of the clusters map to a matching event, the beacon 104 is considered to be an event beacon. For example, if a quantity of the clusters matching an event location 310 satisfies the pre-defined threshold value 316 at 406, the beacon 104 is identified as an event beacon at 408.

As an example, for each cluster [symbol] _{l,b}_{ᵢ}, wherein l is the cluster number and bᵢ is the beacon identifier, the computing device 302 calls CheckConf(t_{min,l}, t_{max,l}, location( [symbol] _{l,b}_{ᵢ})) which takes the following fields as input.

t_{min,l}: the minimum time stamp of all position observations 204 for the beacon 104 in cluster l

t_{max,l}: the maximum time stamp of all position observations 204 for the beacon 104 in cluster l

location( [symbol] _{l,b}_{ᵢ}) : location of the cluster l (e.g., as planetary coordinates including a latitude and longitude)

The computing device 302 compares the quantity of calls to CheckConf( ) that return a null value with the quantity of calls to CheckConf( ) that return a matching event location 310. If the ratio satisfies the pre-defined threshold value 316 (e.g., more calls return a matching event location 310 than a null value, or the ratio exceeds a percentage, etc.), then the beacon 104 is marked as an event beacon.

In this example, satisfying the pre-defined threshold value 316 includes one or more of the following, based on how the pre-defined threshold value 316 is defined: exceeding the pre-defined threshold value 316, not exceeding the pre-defined threshold value 316, and equaling the pre-defined threshold value 316. If the quantity of clusters matching an event location 310 does not satisfy the pre-defined threshold value 316, the beacon 104 is not identified as an event beacon at 410. In some embodiments, the computing device 302 further assigns the event location 310 of the matching event as the location of the beacon 104.

Referring next to FIG. 5, an exemplary flow chart illustrates a clustering analysis of the position observations 204 for a beacon 104. The operations illustrated in FIG. 5 perform one example of a clustering analysis, although aspects of the disclosure are operable with other clustering analyses. Execution of an exemplary k-means algorithm is described with reference to FIG. 5, but aspects of the disclosure are operable with any k-means algorithm or other clustering analysis.

Each of the mobile computing devices 102 creates a record identifying a beacon 104 observed by the mobile computing device 102 while the mobile computing device 102 is at a particular location at a particular time. For example, each record [symbol] _{b}_{ᵢ}_{,t}_{ⱼ} includes the following fields:
bᵢ: beacon identifier (e.g. WiFi media access control address, mobile country code, mobile operator code, location area code, and/or cell identifier)
tⱼ: timestamp (e.g. in coordinated universal time)
location( [symbol] _{b}_{ᵢ}_{,t}_{ⱼ}): the location of the mobile computing device 102 (e.g., as planetary coordinates including a latitude and longitude as determined by a global positioning system, or a signature of location such as a list of cellular towers)

The records may include more or less information. For example, the timestamp may be expanded to include a first observed time (e.g., the earliest observed time) and a last observed time (e.g., the most recent observed time). The records are collected from the plurality of mobile computing devices 102 and processed to create a set of observations representing the crowd-sourced data. For example, the mobile computing devices 102 send the records to a server such as computing device 302. The server, or another computing device separate from the server, may create the set of observations. In some embodiments, each of the observations has the following factors, properties, or dimensions: a latitude and longitude (of the observing mobile computing device 102), first observed time, and last observed time.

At 502, the server receives or accesses the set of observations relating to a beacon B. At 504, the server calculates the probable position of the beacon B using the set of observations. The server calculates the probable position of the beacon B based on the crowd-sourced data using a location determination algorithm such as known in the art. The output of the location determination algorithm is a probable position P that, in some embodiments, includes the following factor, properties, or dimensions: latitude and longitude (of the beacon B), an error radius, a first observed time and a last observed time. For example, the location determination algorithm computes position P_{b}_{ᵢ} based on all records [symbol] _{b}_{ᵢ}_{,t}_{ⱼ} for beacon i. In some embodiments, the position P_{b}_{ᵢ} is composed of the following fields:
bᵢ: beacon identifier (e.g. WiFi media access control address, mobile country code, mobile operator code, location area code, and/or cell identifier)
location(P_{b}_{ᵢ}): location of the beacon (e.g. as planetary coordinates including a latitude and longitude)
radius(P_{b}_{ᵢ}): radius of the beacon

The server compares the determined error radius with a pre-defined threshold radius. The pre-defined threshold radius is based on factors such as, but not limited to, the type of beacon 104 and/or historical data. For example, the pre-defined threshold radius for a WiFi beacon may be 500 meters, while the pre-defined threshold radius for a GSM beacon may be 10 kilometers. In some embodiments, the pre-defined threshold radius is obtained by a function call such as RadiusThreshold(BeaconType(B)). If the error radius is less than the pre-defined threshold radius at 506, then the server publishes P as the position for beacon B at 508. If the error radius is greater than the pre-defined threshold radius at 506, the server applies a k-means clustering algorithm on the set of observations at 510. For example, if radius(P_{b}_{ᵢ})>R_{b}_{ᵢ}, where R_{b}_{ᵢ} is the predefined threshold radius for the beacon type associated with beacon B, the server considers the beacon to be either a moved beacon or a moving beacon. As such, the beacon B is a candidate for clustering.

The k-means clustering algorithm produces a set of K clusters each having a position and a set of observations. The k-means algorithm starts with K=2 and the geographic distance between each observation position (e.g., latitude and longitude) and the cluster centroid as the dimension. For example, the server applies the k-means clustering algorithm on all record [symbol] _{b}_{ᵢ}_{,t}_{ⱼ} for beacon i to compute the clusters [symbol] _{l,b}_{ᵢ} for beacon i. In some embodiments, each cluster [symbol] _{l,b}_{ᵢ} is composed of the following fields:
bᵢ: beacon identifier (e.g. WiFi media access control address, mobile country code, mobile operator code, location area code, and/or cell identifier)
l: the cluster number
location( [symbol] _{l,b}_{ᵢ}): location of the beacon (e.g. as planetary coordinates including a latitude and longitude)
radius( [symbol] _{l,b}_{ᵢ}): radius of the beacon
t_{max,l}: the maximum time stamp of all [symbol] _{b}_{ᵢ}_{,t}_{ᵢ} in [symbol] _{l,b}_{ᵢ}
tₘᵢₙ: the minimum time stamp of all [symbol] _{b}_{ᵢ}_{,t}ⱼ in [symbol] _{l,b}_{ᵢ}

If the error radius for any of the clusters is greater than the pre-defined threshold radius at 512, then K is increased by one at 516 (so long as K is not greater than or equal to the maximum value at 514). If K is greater than or equal to the maximum value for K at 514, then the process ends at 518 as an accurate position for beacon B cannot be determined. For example, radius( [symbol] _{l,b}_{ᵢ}>R_{b}_{ᵢ} means that all records [symbol] _{b}_{ᵢ}_{,t}_{ⱼ} for beacon i do not form k clusters, and k should be increased by one. Operations 510, 512, 514, and 516 are repeated until all records [symbol] _{b}_{ᵢ}_{,t}_{ⱼ} for beacon i form k clusters (e.g., either radius( [symbol] _{l,b}_{ᵢ})≦Rₖ or k>kₘₐₓ).

If the error radius for each cluster is less than or equal to pre-defined threshold radius at 512, the process ends at 520 because cohesive clusters and their respective positions have been calculated. In some embodiments, timestamps associated with each cluster are compared to determine whether the timestamps of each cluster are mutually exclusive, further confirming that the beacon 104 has changed positions.

The computing device 302 or server compares the cluster positions with the event information 110 to determine whether the beacon 104 is an event beacon, such as shown and described with reference to FIG. 4.

Referring next to FIG. 6, an exemplary flow chart illustrates operation of the computing device 302 to determine the position of a mobile computing device 102 using event locations 310. At 602, the computing device 302 receives a location request from the mobile computing device 102. For example, the communications interface component 320, when executed by the processor 304, causes the processor 304 to receive the location request from the mobile computing device 102. The location request identifies a set of beacons 104 observed by the mobile computing device 102. The computing device 302 compares the set of observed beacons 104 with a set of known event beacons and a set of stationary beacons of known location (e.g., cell towers) to determine whether the mobile computing device 102 may be near an event. If the set of observed beacons 104 includes at least one of the event beacons at 604 and at least one of the stationary beacons of known location at 606, the computing device 302 compares the known location of the stationary beacon with the event information 110 at 608 to determine whether there is a matching event location at 610.

For example, the memory component 318, when executed by the processor 304, causes the processor 304 to access the event locations 310 and corresponding events 308. In some embodiments, the memory component 318 requests the event locations 310 and corresponding events 308 from a cloud-based service. The conference component 322, when executed by the processor 304, causes the processor 304 to compare the known location with the event locations 310 accessed by the memory component 318 to identify a matching event location 310. In some embodiments, the conference component 322 filters the event locations 310 based on a current time and identifies the matching event location 310 by comparing the known location with the filtered event locations 310.

If there is a matching event location 310, the computing device 302 assigns the matching event location 310 as the location of the mobile computing device 102. The computing device 302 provides the matching event location 310 to the mobile computing device 102 at 612 in response to the received request. For example, the communications interface component 320 sends the matching event location 310 to the mobile computing device 102.

If the computing device 302 is unable to use the event information 110 to aid in determining the location of the mobile computing device 102, the computing device 302 proceeds to determine the position of the mobile computing device 102 at 614 using the set of observed beacons 104 as input to any location service 106 algorithm.

Alternatively, the mobile computing device 102 may receive a location determination from a location service that does not check the event information 110. The mobile computing device 102 (e.g., the operating system or an application) provides the received location determination to a service that then checks the received location and the observed beacons 104 against the event information 110 to further refine the location determination.

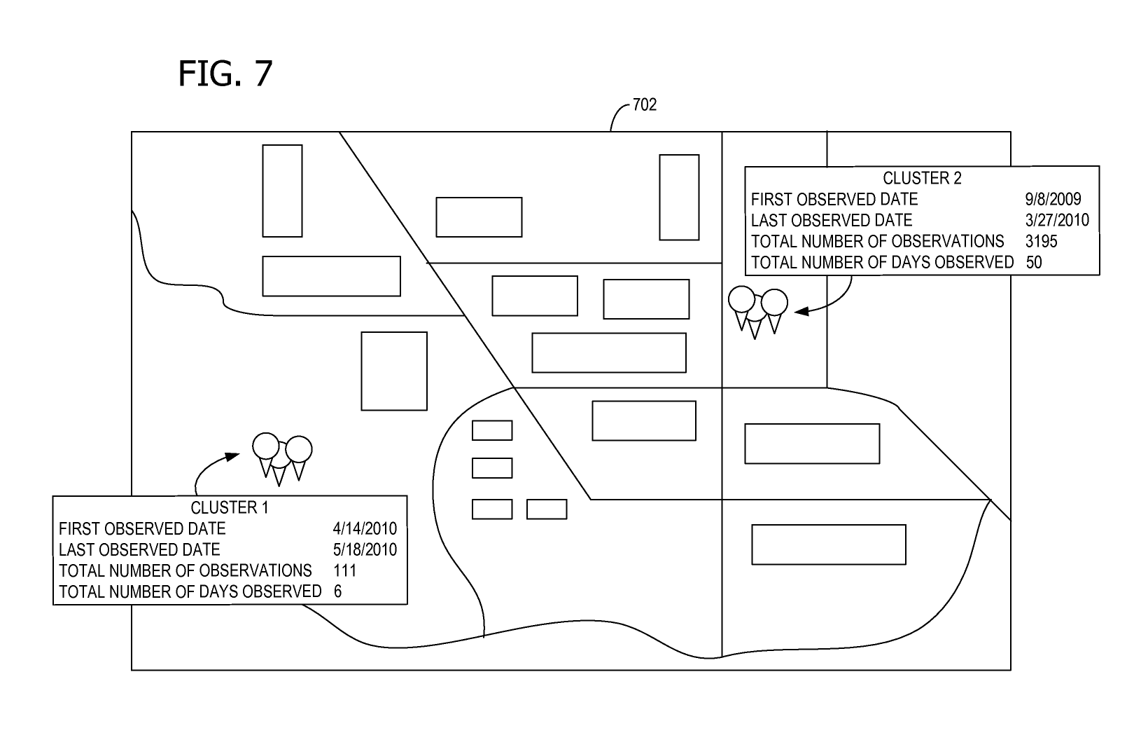

Referring next to FIG. 7, an exemplary block diagram illustrates a map 702 showing two clusters of position observations for a particular beacon. In this example, there are two clusters. In Cluster 1, the first observed date is Apr. 14, 2010, the last observed date is May 18, 2010, there are 111 observations associated with the beacon, and the beacon was observed for 6 days. In Cluster 2, the first observed date is Sep. 8, 2009, the last observed date is Mar. 27, 2010, there are 3195 observations associated with the beacon, and the beacon was observed for 50 days. In the example of FIG. 7, the clustering algorithm (e.g., such as illustrated in FIG. 5) identifies Cluster 1 and Cluster 2 as cohesive, mutually exclusive clusters.

### ADDITIONAL EXAMPLES

In some embodiments, the event information 110 includes future event locations. The computing device 302 can predict a future location for a particular event beacon based on the future event locations.

Aspects of the disclosure may detect when the beacon 104 has moved by analyzing each set of observations received from the mobile computing devices 102. For example, the mobile computing device 102 may send a set of observed beacons 104 including an event beacon along with a location of the mobile computing device 102 to the location service 106. The location service 106 compares the location of the mobile computing device 102 with the event information 110 for the event beacon. If the event location 310 for the event beacon as determined from the event information 110 is far from the location of the mobile computing device 102, the location service 106 infers that the event beacon has moved. The location service 106 then updates the position of the beacon 104 to be the event location 310.

At least a portion of the functionality of the various elements in FIG. 3 may be performed by other elements in FIG. 3, or an entity (e.g., processor, web service, server, application program, computing device, etc.) not shown in FIG. 3.

In some embodiments, the operations illustrated in FIG. 4, FIG. 5, and/or FIG. 6 may be implemented as software instructions encoded on a computer-readable medium, in hardware programmed or designed to perform the operations, or both. For example, aspects of the disclosure may be implemented as a system on a chip.

While no personally identifiable information is tracked by aspects of the disclosure, embodiments have been described with reference to data monitored and/or collected from users. In such embodiments, notice is provided to the users of the collection of the data (e.g., via a dialog box or preference setting) and users are given the opportunity to give or deny consent for the monitoring and/or collection. The consent may take the form of opt-in consent or opt-out consent.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media store information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

Although described in connection with an exemplary computing system environment, embodiments of the invention are operational with numerous other general purpose or special purpose computing system environments or configurations. Examples of well known computing systems, environments, and/or configurations that may be suitable for use with aspects of the invention include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

Aspects of the invention transform a general-purpose computer into a special-purpose computing device when configured to execute the instructions described herein.

The embodiments illustrated and described herein as well as embodiments not specifically described herein but within the scope of aspects of the invention constitute exemplary means for identifying the beacon 104 as an event beacon, exemplary means for associating the beacon 104 with the event, and exemplary means for identifying the plurality of clusters of the position observations for the beacon 104.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for associating a beacon with an event, said system comprising:
a memory area associated with a computing device, said memory area storing a plurality of position observations for a beacon, said memory area further storing event information including event locations and events corresponding thereto, said memory area further storing a pre-defined threshold value; and
a processor programmed to:
identify a plurality of clusters of the position observations for the beacon, said clusters being defined by spatial distance, each of the plurality of clusters having a location associated therewith;
compare the location of each of the clusters with the event locations stored in the memory area to identify a matching event;
compare a quantity of the matching events to a pre-defined threshold value; and
based on the comparison of the quantity of the matching events to the pre-defined threshold value, associate the beacon with the matching event.

2. The system of claim 1, wherein the event information stored in the memory area describes one or more of the following: past events, present events, and future events.

3. The system of claim 1, wherein the processor is further programmed to assign the event location of the matching event to the beacon.

4. The system of claim 1, wherein the plurality of position observations comprise crowd-sourced records each identifying one or more beacons observed by one of a plurality of mobile computing devices.

5. The system of claim 1, wherein the processor is further programmed to obtain the event information via a web crawler.

6. The system of claim 1, further comprising means for identifying the beacon as an event beacon, and means for associating the beacon with the event.

7. The system of claim 1, further comprising means for identifying the plurality of clusters of the position observations for the beacon.

8. A method comprising:
identifying, by a computing device, a plurality of clusters of position observations for a beacon, said clusters being defined by spatial distance, each of the plurality of clusters having a location associated therewith;
comparing the location of each of the plurality of clusters with event locations, each of the event locations corresponding to at least one event; and
based on the comparison, associating the beacon with the event.

9. The method of claim 8, further comprising defining the beacon as an event beacon.

10. The method of claim 8, wherein each of the plurality of clusters has a time associated therewith, and wherein comparing the location of each of the plurality of clusters with event locations comprises comparing the location and time of each of the plurality of clusters with the event locations and event times associated therewith.

11. The method of claim 8, further comprising receiving the position observations from a plurality of mobile computing devices.

12. The method of claim 8, wherein identifying the plurality of clusters comprises grouping the position observations for the beacon into a plurality of clusters.

13. The method of claim 8, further comprising calculating the location of each of the plurality of clusters.

14. The method of claim 8, further comprising receiving the position observations from a mobile computing device, wherein the position observations include a location of the mobile computing device and a set of beacons observed by the mobile computing device.

15. The method of claim 8, further comprising:
accessing one or more future event locations associated with the event;
predicting a future location for the beacon based on the accessed future event locations.

16. The method of claim 8, wherein identifying the plurality of clusters comprises performing a k-means clustering algorithm.

17. One or more computer-readable media having computer-executable components, said components comprising:
a memory component that when executed by at least one processor causes the at least one processor to access event locations and corresponding events;
a communications interface component that when executed by at least one processor causes the at least one processor to receive a location request from a computing device, said location request including a set of beacons observed by the computing device, wherein the set of beacons includes an event beacon and a stationary beacon of known location; and
a conference component that when executed by at least one processor causes the at least one processor to compare the known location with the event locations accessed by the memory component to identify a matching event location, wherein the communications interface component sends the matching event location to the computing device as the location of the computing device.

18. The computer-readable media of claim 17, wherein the memory component, the communications interface component, and the conference component are associated with a cloud-based service.

19. The computer-readable media of claim 17, wherein the memory component accesses event locations and corresponding events by requesting the event locations and corresponding events from a cloud-based service.

20. The computer-readable media of claim 17, wherein the conference component filters the event locations based on a current time, and identifies the matching event location by comparing the known location with the filtered event locations.
